(19) United States
(12) Patent Application Publication
(10) Pub. No.: US 2012/0018290 A1
(43) Pub. Date: Jan. 26, 2012

(54) KEY STRUCTURE

(75) Inventors: JIN-HAI GUO, Shenzhen City (CN); KUAN-HUNG CHEN, Shindian (TW); YONG-GANG ZHANG, Shenzhen (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 12/940,156

(22) Filed: Nov. 5, 2010

(30) Foreign Application Priority Data
Jul. 23, 2010 (CN) 201010235448.3

(51) Int. Cl. H01H 13/76; H01H 1/10

(52) U.S. Cl. 200/5 A

(57) ABSTRACT

A key structure includes a substrate, a key cover positioned on the substrate, a first fixed contact, a second fixed contact and a conductive portion. The key cover includes a first movable contact, a second movable contact and a fixed portion. The first movable contact, the second movable contact and the fixed portion are located at inner surface of the key cover. The first fixed contact, the second fixed contact and the conductive portion are electrically positioned on the substrate and correspond to the first movable contact, the second movable contact and the fixed portion. When the key cover deforms, the first movable contact and the second movable contact move toward the substrate, the second movable contact and the first movable contact electrically contact the second fixed contact and the second fixed contact to generate a first command signal and a second command signal.

### BACKGROUND

1. Technical Field

The disclosure generally relates to input devices, and more particularly relates, to a key structure used in an electronic device.

2. Description of the Related Art

Different control keys are often used in mobile phones, personal digital assistants (PDAs), or other electronic devices, such as cameras. When depressed, the movable contacts of the keys elastically and electrically contact and connect the circuit boards in the electronic devices, to activate corresponding functional circuits. When the keys are released, the movable contacts disconnect from the circuit board to switch the functional circuits off.

However, conventional key structures typically provide only limited operations, merely on and off states.

Therefore, there is room for improvement within the art.

### BRIEF DESCRIPTION OF THE DRAWINGS

Many aspects of an exemplary key structure can be better understood with reference to the following drawings. The components in the drawings are not necessarily drawn to scale, the emphasis instead being placed upon clearly illustrating the principles of the exemplary key structure. Moreover, in the drawings, like reference numerals designate corresponding parts throughout the several views. Wherever possible, the same reference numbers are used throughout the drawings to refer to the same or like elements of an embodiment.

FIG. 1 is an exploded view of a key structure, according to an exemplary embodiment.

FIG. 2 is an assembled view of the key structure shown in FIG. 1.

FIG. 3 is an assembled cross-sectional view of the key structure taken along line of FIG. 2.

FIG. 4 is an assembled cross-sectional view of the key structure in a first operating state.

FIG. 5 is an assembled cross-sectional view of the key structure in a second operating state.

### DETAILED DESCRIPTION

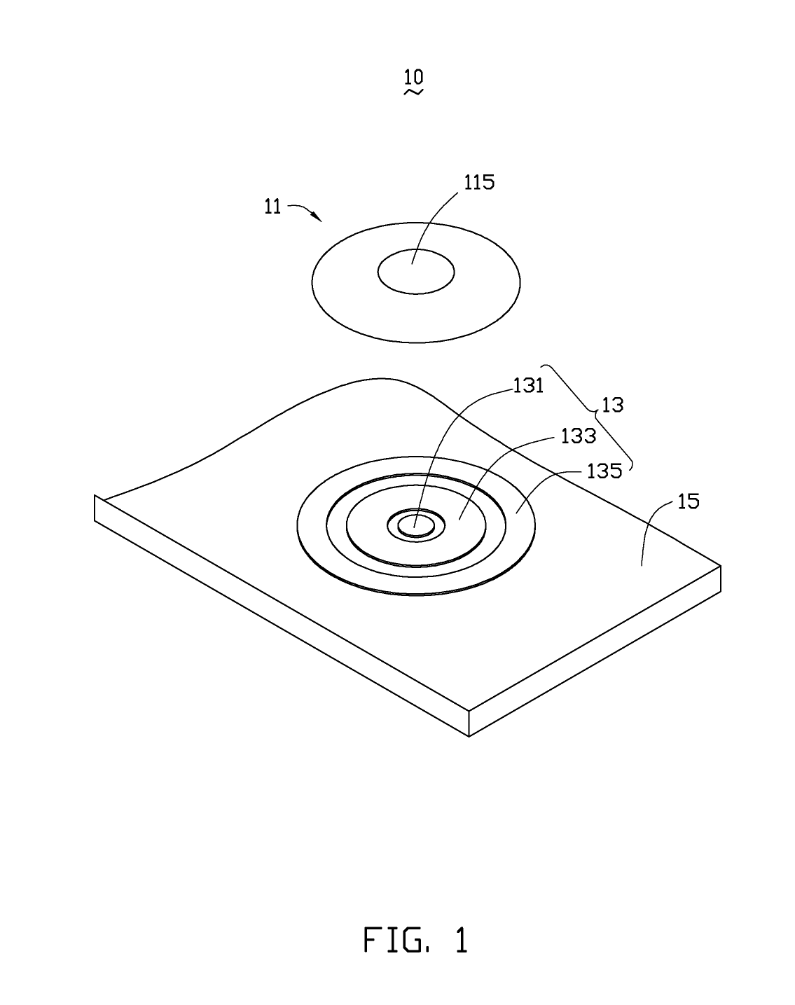

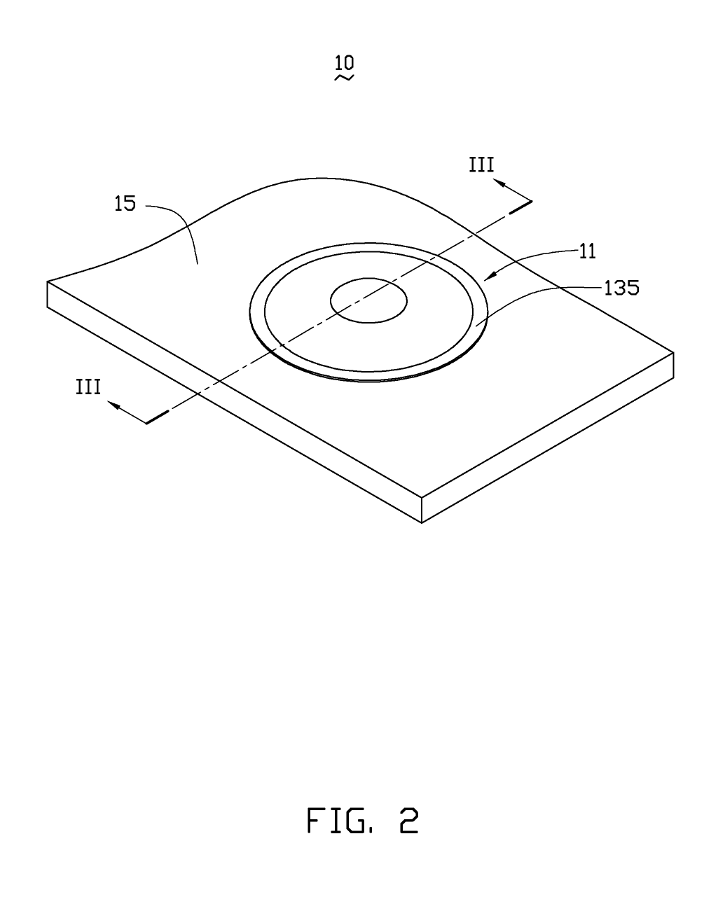

FIGS. 1 and 2 show an exemplary embodiment of a key structure 10 used in an electronic device, such as a mobile phone or a PDA. The key structure 10 includes a key cover 11, a fixed contact member 13, and a substrate 15. The fixed contact member 13 is electrically connected to and mounted on the upper surface of the substrate 15 and faces the underside of the key cover 11.

The substrate 15 may be a printed circuit board (PCB) used for layout of electronic components and different function circuits. The fixed contact member 13 is positioned on the substrate 15 and is electrically connected to corresponding key circuits and/or switch circuits.

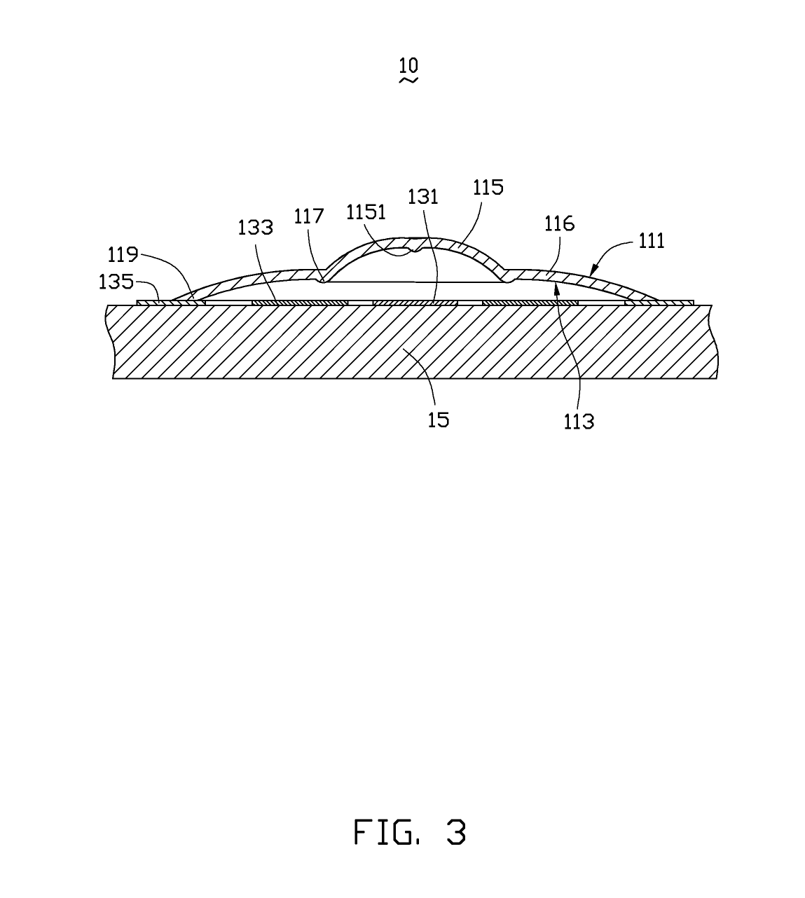

Referring to FIG. 3, the key structure 10 is in a rest state. The key cover 11 is made of elastic material, such as stainless steel or copper alloy, formed by punching and/or cutting a piece of metal. The key cover 11 includes an outer surface 111, an inner surface 113, an operating portion 115, and a movable contact spring 116. The operating portion 115 is substantially a dome of elastic metal and includes a first movable contact 1151 formed at the apex or adjacent to the apex of the operating portion 115 near the radial center of the operating portion 115. The first movable contact 1151 protrudes from the inner surface 113. The operating portion 115 is capable of elastically deforming to electrically contact and/or disconnect the fixed contact member 13 and the movable contact 1151.

The movable contact spring 116 is substantially a domed extension from operating part 15 and formed in a peripheral surface which can be elastically reversibly deformed. The movable contact spring 116 includes a second movable contact 117 provided on the domed inner surface 113. The second movable contact 117 is positioned at the junction of the operating portion 115 and the movable contact spring 116, having a predetermined diameter about a center of the apex of the operating portion 115, spaced radially away from (radially outside) the operating portion 115. The second movable contact 117 protrudes from the domed inner surface 113, and may have a circular shape on the inner surface 113, and is formed by half-cut working by use of a pressing machine. Moreover, the circular second movable contact 117 is not just limited to the circular shape, can also be punched and/or cut into pluralities of different parts, such as elliptical parts, oval parts, rectangular parts, square parts, and other polygonal parts arranged on the same circle on the inner surface 113.

The movable contact spring 116 further includes a circular fixed portion 119 at the periphery thereof. The fixed contact member 13 includes a first fixed contact 131, a second fixed contact 133 around the first fixed contact 131, and a conductive portion 135 around the second fixed contact 133. The first fixed contact 131, the second fixed contact 133 and the conductive portion 135 are made of copper foil or other conductive metal on the upper surface of the substrate 15, normally by print wiring technique.

The first fixed contact 131 faces the first movable contact 1151, the shape and the size of the first fixed contact 131 match the shape and the size of the first movable contact 1151. The second fixed contact 133 may form a substantially circular shape on the upper surface of the substrate 15, and can be cut into different parts, such as elliptical parts, oval parts, rectangular parts, square parts, and other polygonal parts. The size and the shape of the second fixed contact 133 match the size and the shape of the second movable contact 117, and the second fixed contact 133 is substantially aligned with the second movable contact 117, respectively.

The conductive portion 135 forms a shape on the upper surface of the substrate 15 conforming to the fixed portion 119 and can be obtained by punching and/or cutting a piece of metal belt. The conductive portion 135 is substantially aligned with the circular fixed portion 119. The first fixed contact 131, the second fixed contact 133 and the conductive portion 135 are substantially concentric circles and are electrically connected different corresponding function circuits. Thus, the first movable contact 1151 and the second movable contact 117 contact or break off the contact with the opposed fixed first contact 131 and the second fixed contact 133 to electrically connect or disconnect different key circuits, switch circuits or other function circuits.

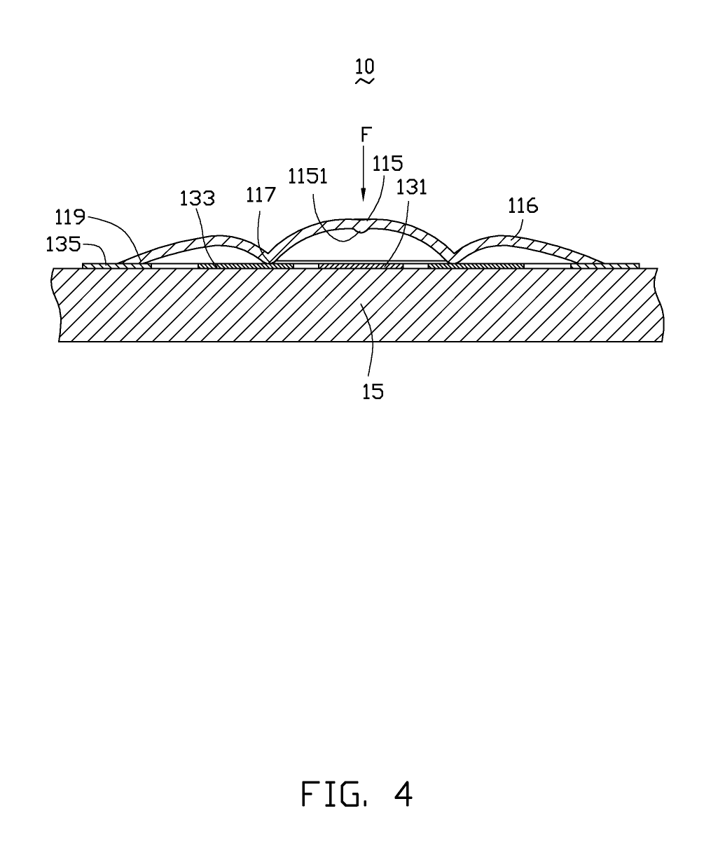

Further referring to FIG. 4, in use, the fixed portion 119 is electrically connected to the conductive portion 135, a downward operating load F acts on the central part of the operation portion 115. The operation portion 115 deforms and moves downwardly toward the substrate 15, elastically deforming the movable contact spring 116 until the second movable contact 117 electrically connects or contacts the second fixed contact 133. Thus, the key structure 10 is switched from an off state to an operating state and generates a corresponding first command signal, and electrically connects corresponding function circuits to operate the electronic device. At this time, the key structure 10 is in a first operating state.

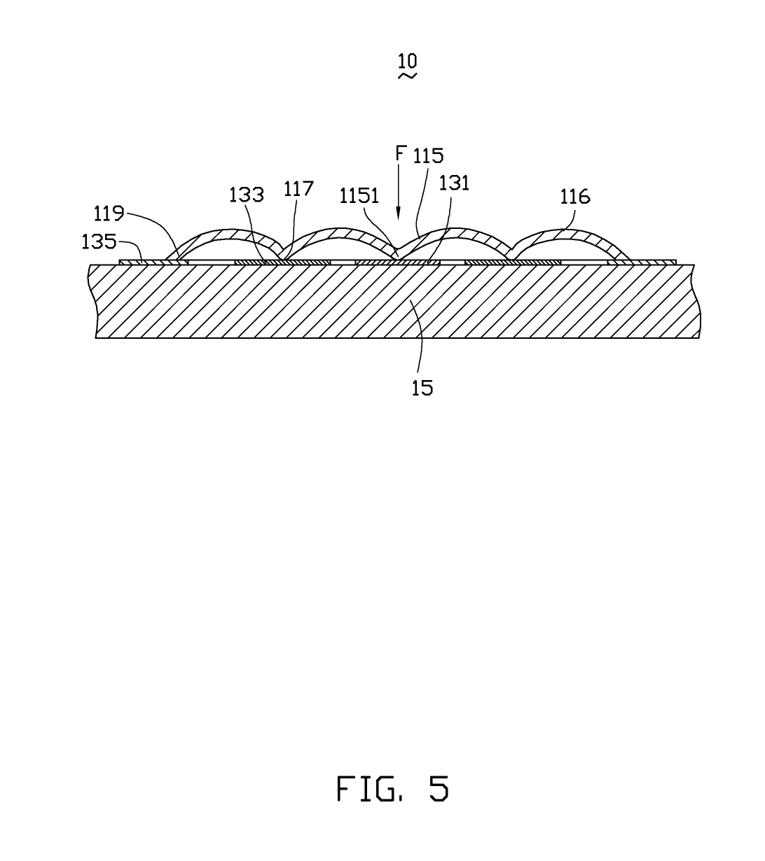

Further referring to FIG. 5, pressure on the central part of the operation portion 115 in the direction of the operating load F, further deforms and moves the operation portion 115 downwardly relative to the substrate 15. The operation portion 115 elastically deforms from the central part until the first movable contact 1151 electrically connects and contacts the first fixed contact 131. Thus, the key structure 10 is switched from an operating state to another operating state and is triggered to generate a corresponding second command signal, and electrically connects corresponding function circuits to operate the electronic device. At this time, the key structure 10 is in a second operating state.

Moreover, when the operating load F is released from the operation portion 115, the elastic deformations of the operation portion 115 and the movable contact spring 166 are recovered. Thus, the first movable contact 1151 is electrically disconnected from the first fixed contact 131, the second movable contact 117 is electrically and elastically disconnected from the first second contacts 133, and the key structure 10 resumes from the operating state to the off state. The first fixed contact 131, the second fixed contact 133 and the conductive portion 135 are electrically disconnected from each other.

In summary, in the key structure 10 of the exemplary embodiment, the first movable contact 1151 and the second movable contact 117 respectively face the first fixed contact 131 and the second fixed contact 133. When different operating loads F act on the operation portion 115, the first movable contact 1151 and the second movable contact 117 respectively electrically connect and contact the first fixed contact 131 and the second fixed contact 133. Thus, the key structure 10 is switched from the off state to corresponding operating states, and generates corresponding command signals, and electrically connects corresponding function circuits to operate the electronic device.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. A key structure, comprising:
a substrate for providing different function circuits;
a key cover electrically and elastically positioned on the substrate, the key cover comprising a first movable contact and a second movable contact radially outside the first movable contact;
a first fixed contact positioned on the substrate and electrically connected to the function circuits, the first fixed contact corresponding to first movable contact; and
a second fixed contact positioned on the substrate and electrically connected to the function circuits, wherein the second fixed contact corresponds to the second movable contact, the key cover elastically deforms relative to the substrate, the first movable contact and the second movable contact electrically and respectively contact and connect the first fixed contact and the second fixed contact, and the key structure is switched from an off state to operating states.

2. The key structure as claimed in claim 1, wherein the key cover is made of elastic material and is formed by punching and/or cutting a piece of metal.

3. The key structure as claimed in claim 1, wherein the key cover further comprises a domed inner surface, the first movable contact protrudes from the inner surface and faces the first fixed contact, the second movable contact protrudes from the inner surface and forms a circular shape on the inner surface.

4. The key structure as claimed in claim 1, wherein the key cover further comprises a fixed portion at the periphery of the key cover, the key structure further comprises a conductive portion positioned on the substrate and radially outside the second fixed contact, the fixed portion electrically contacts and connects the conductive portion.

5. A key structure, comprising:
a substrate;
a key cover elasticably positioned on the substrate, the key cover comprising:
a first movable contact;
a second movable contact radially outside the first movable contact; and
a fixed portion around the second movable contact, the first movable contact, the second movable contact and the fixed portion located at inner surface of the key cover;
a first fixed contact electrically positioned on the substrate and corresponding to the first movable contact;
a second fixed contact electrically positioned on the substrate and radially outside the first fixed contact, the second fixed contact corresponding to the second movable contact; and
a conductive portion electrically positioned on the substrate and around the second fixed contact, the conductive portion electrically facing and contacting the fixed portion, wherein the key cover deforms relative to the substrate, the first movable contact and the second movable contact move toward the substrate, the second movable contact electrically contacts the second fixed contact to generate a first command signal, and the first movable contact moves toward the substrate and electrically contacts the first fixed contact to generate a second command signal.

6. The key structure as claimed in claim 5, wherein the key cover is made of elastic material and is formed by punching and/or cutting a piece of metal.

7. The key structure as claimed in claim 5, wherein the key cover is made of stainless steel or copper alloy.

8. The key structure as claimed in claim 5, wherein the key cover further comprises a domed inner surface, the first movable contact protrudes from the inner surface, and the second movable contact protrudes from the inner surface and forms a circular shape on the inner surface of the key cover.

9. The key structure as claimed in claim 8, wherein the second movable contact is punched and/or cut into pluralities of different parts arranged on the inner surface.

10. The key structure as claimed in claim 5, wherein the second movable contact and the fixed portion are circular, the second fixed contact and the conductive portion are circular, and the second fixed contact and the conductive portion are substantially concentric circles and are electrically connected to different corresponding function circuits.

11. The key structure as claimed in claim 5, wherein the first movable contact and the second movable contact or break off the contact with the opposed fixed first contact and the second fixed contact to electrically connect or disconnect different function circuits.

12. A key structure, comprising:
a substrate;
a key cover elasticably positioned on the substrate, the key cover comprising:
a first movable contact located at inner surface of the key cover;
a second movable contact at the inner surface and radially outside the first movable contact; and
a fixed portion at the inner surface of the key cover and around the second movable contact;
a first fixed contact corresponding to the first movable contact;
a second fixed contact around the first fixed contact, the second fixed contact corresponding to the second movable contact; and
a conductive portion around the second fixed contact and electrically contacting and facing the fixed portion, the first fixed contact, the second fixed contact and the conductive portion electrically positioned on the substrate, wherein the key cover elastically deforms relative to the substrate, the first movable contact and the second movable contact move toward the substrate, the first movable contact and the second movable contact or break off the contact with the opposed fixed first contact and the second fixed contact to change the key structure from a rest state to a first operating state and further to a second operating state.

13. The key structure as claimed in claim 12, wherein the key cover is made of elastic material and is formed by punching and/or cutting a piece of metal.

14. The key structure as claimed in claim 12, wherein the key cover is made of stainless steel or copper alloy.

15. The key structure as claimed in claim 12, wherein the key cover further comprises a domed inner surface, the first movable contact protrudes from the inner surface, and the second movable contact protrudes from the inner surface and forms a circular shape on the inner surface of the key cover.

16. The key structure as claimed in claim 15, wherein the second movable contact is punched and/or cut into pluralities of different parts arranged on the inner surface.

17. The key structure as claimed in claim 12, wherein the second movable contact and the fixed portion are circular, the second fixed contact and the conductive portion are circular, and the second fixed contact and the conductive portion are substantially concentric circles and are electrically connected to different corresponding function circuits.

18. The key structure as claimed in claim 12, wherein the second movable contact electrically connects the second fixed contact, the key structure is switched from an off state to an operating state and generates a corresponding first command signal, and the second movable contact electrically connects corresponding function circuits.

19. The key structure as claimed in claim 18, wherein the first movable contact is electrically connected to the first fixed contact, the key structure is switched from an operating state to another operating state and trigger to generate a corresponding second command signal, and the first movable contact electrically connects corresponding function circuits.
